(19) United States
(12) Patent Application Publication
(10) Pub. No.: US 2026/0093220 A1
(43) Pub. Date: Apr. 2, 2026

(54) INDUSTRIAL SIMULATION DATA WITHIN DIGITAL TWIN VISUALIZATIONS

(71) Applicant: Rockwell Automation Technologies, Inc., Mayfield Heights, OH (US)

(72) Inventors: Irfanuddin Shafi Ahmed, Abu Dhabi (AE); Irfan Rayachuru, Bengaluru (IN)

(21) Appl. No.: 18/902,078

(22) Filed: Sep. 30, 2024

(51) Int. Cl. G05B 17/02

(52) U.S. Cl. CPC G05B 17/02

(57) ABSTRACT

A method may include receiving one or more datasets associated with one or more industrial devices within an industrial system, simulating one or more processes performed by the one or more industrial devices based on the one or more datasets, and presenting a digital representation of the industrial system based on the one or more processes. The method also involves receiving a request for one or more visualization tools associated with one or more digital assets corresponding to the one or more industrial devices within the digital representation, identifying one or more positions for the one or more visualization tools based on one or more available spaces within the digital representation, overlaying the one or more visualization tools at the one or more positions.

### BACKGROUND

This disclosure generally relates to industrial automation systems. More particularly, embodiments of the present disclosure are directed towards enhancing visualizations provided with digital twin simulations of industrial automation systems.

To better maintain operations of industrial automations, digital twins (e.g., simulations) representing assets within the industrial automation systems are generated to enable operators to analyze the manner in which the physical industrial automation systems are operating. Improvements to digital twin implementations may better enable operators to analyze digital twin data and make adjustments to the corresponding industrial automation systems.

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a method may include receiving one or more datasets associated with one or more industrial devices within an industrial system, simulating one or more processes performed by the one or more industrial devices based on the one or more datasets, and presenting a digital representation of the industrial system based on the one or more processes. The method also involves receiving a request for one or more visualization tools associated with one or more digital assets corresponding to the one or more industrial devices within the digital representation, identifying one or more positions for the one or more visualization tools based on one or more available spaces within the digital representation, overlaying the one or more visualization tools at the one or more positions.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an example industrial automation system, in accordance with an embodiment presented herein;

FIG. 2 is a block diagram of an industrial automation device management system that may be used to remotely access the industrial automation system of FIG. 1, in accordance with an embodiment presented herein;

FIG. 3 a block diagram of an example edge computing device with containers that may be used in the industrial automation device management system of FIG. 2, in accordance with an embodiment presented herein;

FIG. 4 is a flow diagram of a process for operating a digital representation of the industrial automation system of FIG. 1 using the edge computing device of FIG. 3, in accordance with an embodiment presented herein;

FIG. 5 is an example visualization of the digital representation of an example industrial automation system, in accordance with an embodiment presented herein; and

FIG. 6 is an example visualization tool overlayed on the digital representation of the example industrial automation system, in accordance with an embodiment presented herein.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As digital twin technology becomes more and more prevalent, there are many potential uses for digital twins implemented on industrial automation devices. For example, three dimensional (3D) modeling may be used to create a device level digital twin (e.g., device twin) representing a physical industrial automation device. The device level digital twin may be used to monitor operations of the industrial automation device and simulate operations to identify potential improvement opportunities or issues.

In some embodiments, the device twins corresponding to the industrial automation devices may be executed in a cloud computing environment (e.g., using a cloud computing device or system) and the device twins may be integrated into a system level digital twin representing the industrial automation system. Such cloud-based digital twin implementation may utilize cloud computing resources to support operations of the digital twin.

With improvements of edge computing, an edge computing device may also be used to implement the digital twin representing the industrial automation system described above. Implementing the digital twin on the edge that is closer to the industrial automation devices may reduce response time of the digital twin and communication time. In some embodiments, the edge computing device may implement the digital twin by executing a container obtained from a cloud-based computing system containing a container registry. The container registry may include a collection of containers corresponding to a variety of industrial automation devices (e.g., including devices currently employed and available for future employment in the industrial automation system). Using the container allows the digital twin to be implemented regardless a host environment (e.g., operating system, library dependency) in which the digital twin is operating. The edge computing device may receive data from the industrial automation devices. Instead of sending the data directly to the cloud-based computing system, the edge device may identify those attributes having changes and only communicate the attribute changes to the cloud-based computing system. In this way, the edge computing device may reduce the amount of data communicated within (or out of) the industrial automation system and increase network bandwidth availability.

In any case, embodiments of the present disclosure are generally directed towards an industrial automation system that may utilize an edge computing device or any suitable computing device to implement a digital representation (e.g., digital twin) of the industrial automation system. The edge computing device may use the digital representation to simulate processes of the industrial automation system. Based on the simulation, the edge device may cause one or more industrial automation devices to modify the processes to facilitate monitoring, operation, optimization, maintenance, and diagnosis of the industrial automation system. Moreover, the edge computing device may dynamically update the digital representation using updated data from the industrial automation devices. For example, the updated data may include an identifier associated with an industrial automation device and attribute values that may indicate potential optimizations or issues associated with the industrial automation devices.

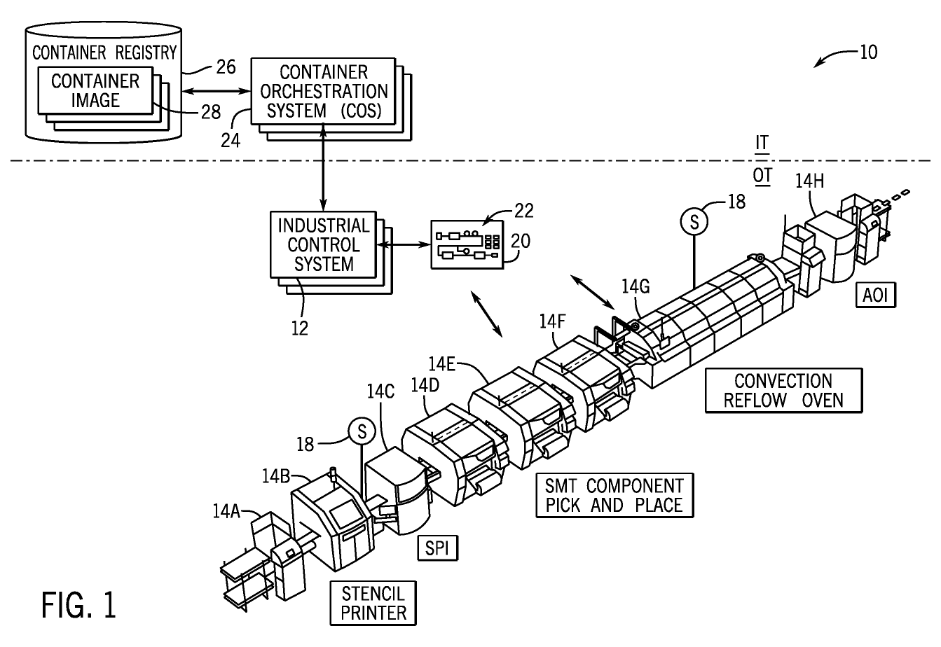

In some embodiments, the digital representation (e.g., twin or simulations) may be generated using various tools. However, these tools are limited with regard to providing analysis visualizations in a flexible manner while viewing the digital twin visualizations. In some embodiments, as the digital twin or simulation is being executed, virtual analytic graphs may be placed within the digital twin representation, such that the graphs are overlaid onto the digital twin visualization to provide real time insight into the expected performance of the various equipment. Indeed, the graphs may change dynamically based on the continued execution or operation of the digital twin. In this way, the user may monitor the trends or data changes in a position adjacent to the respective device being analyzed. Further, the user may input a target or set point directly into the analytic graph, thereby causing a control system to determine adjustments to respective assets in the industrial automation system to implement to achieve the target point. The control system may then send commands to the respective devices to modify their respective operations. Additional details with regard to the embodiments described herein will be details with respect to FIGS. 1-6.

By way of introduction, FIG. 1 is a perspective view of an example industrial automation system 10 controlled by one or more industrial control systems 12. The industrial automation system 10 includes stations 14 having machine components and/or machines to conduct functions within an automated process, such as silicon wafer manufacturing, as is depicted. The automated process may begin at a station 14A used for loading objects, such as substrates, into the industrial automation system 10 via a conveyor section 16. The conveyor section 16 may transport the objects to a station 14B to perform a first action, such a printing solder paste to the substrate via stenciling. As objects exit from the station 14B, the conveyor section 16 may transport the objects to a station 14C for solder paste inspection (SPI) to inspect printer results, to a station 14D, 14E, and 14F for surface mount technology (SMT) component placement, to a station 14G for convection reflow oven to melt the solder to make electrical couplings, and finally to a station 14H for automated optical inspection (AOI) to inspect the object manufactured (e.g., the manufactured printed circuit board). After the objects proceed through the various stations, the objects may be removed from the station 14H, for example, for storage in a warehouse or for shipment. Clearly, for other applications, the particular system, machine components, machines, stations, and/or conveyors may be different or specially adapted to the application.

For example, the industrial automation system 10 may include machinery to perform various operations in a compressor station, an oil refinery, a batch operation for making food items, chemical processing operations, brewery operations, mining operations, a mechanized assembly line, and so forth. Accordingly, the industrial automation system 10 may include a variety of operational components, such as electric motors, valves, actuators, temperature elements, pressure sensors, or a myriad of machinery or devices used for manufacturing, processing, material handling, and other applications. The industrial automation system 10 may also include electrical equipment, hydraulic equipment, compressed air equipment, steam equipment, mechanical tools, protective equipment, refrigeration equipment, power lines, hydraulic lines, steam lines, and the like. Some example types of equipment may include mixers, machine conveyors, tanks, skids, specialized original equipment manufacturer machines, and the like. In addition to the equipment described above, the industrial automation system 10 may also include motors, protection devices, switchgear, compressors, and the like. Each of these described operational components may correspond to and/or generate a variety of operational technology (OT) data regarding operation, status, sensor data, operational modes, alarm conditions, or the like, that may be desirable to output for analysis with IT data from an IT network, for storage in an IT network, for analysis with expected operation set points (e.g., thresholds), or the like.

In certain embodiments, one or more properties of the industrial automation system 10 equipment, such as the stations 14, may be monitored and controlled by the industrial control systems 12 for regulating control variables. For example, sensing devices (e.g., sensors 18) may monitor various properties of the industrial automation system 10 and may be used by the industrial control systems 12 at least in part in adjusting operations of the industrial automation system 10 (e.g., as part of a control loop). In some cases, the industrial automation system 10 may be associated with devices used by other equipment. For instance, scanners, gauges, valves, flow meters, and the like may be disposed on or within the industrial automation system 10. Here, the industrial control systems 12 may receive data from the associated devices and use the data to perform their respective operations more efficiently. For example, a controller of the industrial automation system 10 associated with a motor drive may receive data regarding a temperature of a connected motor and may adjust operations of the motor drive based on the data.

The industrial control systems 12 may be communicatively coupled to a display/operator interface 20 (e.g., a human-machine interface (HMI)) and to devices of the industrial automation system 10. It should be understood that any suitable number of industrial control systems 12 may be used in a particular industrial automation system 10 embodiment. The industrial control systems 12 may facilitate representing components of the industrial automation system 10 through programming objects that may be instantiated and executed to provide digital representations (e.g., digital twins) having simulated functionality similar or identical to the actual components, as well as visualization of the components, or both, on the display/operator interface 20. The programming objects may include code and/or instructions stored in the industrial control systems 12 and executed by processing circuitry of the industrial control systems 12. The processing circuitry may communicate with memory circuitry to permit the storage of the component visualizations.

As illustrated, a display/operator interface 20 depicts representations 22 (e.g. digital representation with visualizations) of the components of the industrial automation system 10. The industrial control systems 12 may use data transmitted by sensors 18 to update visualizations of the components via changing one or more statuses, states, and/or indications of current operations of the components. These sensors 18 may be any suitable device adapted to provide information regarding process conditions. Indeed, the sensors 18 may be used in a process loop (e.g., control loop) that may be monitored and controlled by the industrial control systems 12. As such, a process loop may be activated based on process inputs (e.g., an input from the sensor 18) or direct input from a person via the display/operator interface 20. The person operating and/or monitoring the industrial automation system 10 may reference the display/operator interface 20 to determine various statuses, states, and/or current operations of the industrial automation system 10 and/or for a particular component. Furthermore, the person operating and/or monitoring the industrial automation system 10 may adjust to various components to start, stop, power-down, power-on, or otherwise adjust an operation of one or more components of the industrial automation system 10 through interactions with control panels or various input devices.

The industrial automation system 10 may be considered a data-rich environment with several processes and operations that each respectively generate a variety of data. For example, the industrial automation system 10 may be associated with material data (e.g., data corresponding to substrate or raw material properties or characteristics), parametric data (e.g., data corresponding to machine and/or station performance, such as during operation of the industrial automation system 10), test results data (e.g., data corresponding to various quality control tests performed on a final or intermediate product of the industrial automation system 10), or the like, that may be organized and sorted as OT data. In addition, sensors 18 may gather OT data indicative of one or more operations of the industrial automation system 10 or the industrial control systems 12. In this way, the OT data may be analog data or digital data indicative of measurements, statuses, alarms, or the like associated with operation of the industrial automation system 10 or the industrial control systems 12.

The industrial control systems 12 described above may operate in an OT space in which OT data is used to monitor and control OT assets, such as the equipment illustrated in the stations 14 of the industrial automation system 10 or other industrial equipment. The OT space, environment, or network generally includes direct monitoring and control operations that are coordinated by the industrial control systems 12 and a corresponding OT asset. For example, a programmable logic controller (PLC) may operate in the OT network to control operations of an OT asset (e.g., drive, motor). The industrial control systems 12 may be specifically programmed or configured to communicate directly with the respective OT assets.

A container orchestration system 24, on the other hand, may operate in an information technology (IT) environment (e.g., a cloud computing environment). That is, the container orchestration system 24 may include multiple computing devices (e.g., cloud computing devices) that coordinates an automatic process of managing or scheduling work of individual containers for applications within the multiple computing devices. In other words, the container orchestration system 24 may be used to automate various tasks at scale across the multiple computing devices. By way of example, the container orchestration system 24 may automate tasks such as configuring and scheduling of containers, provisioning and deployments of containers, determining availability of containers, configuring applications in terms of the containers that they run in, scaling of containers to equally balance application workloads across an infrastructure, allocating resources between containers, performing load balancing, traffic routing and service discovery of containers, performing health monitoring of containers, securing the interactions between containers, and the like. In any case, the container orchestration system 24 may use configuration files to determine a network protocol to facilitate communication between containers, a storage location to save logs, and the like. The container orchestration system 24 may also schedule deployment of containers into hosts (e.g., industrial automation devices) that may execute the containers to implement digital representations (e.g., digital twins) of the industrial automation devices. The digital twins may simulate operations of the industrial automation devices and facilitate monitoring, operation, optimization, maintenance, and diagnosis of the industrial automation devices. Furthermore, the container orchestration system 24 may manage the lifecycle of the containers based on predetermined specifications.

It should be noted that containers refer to technology for packaging an application along with its runtime dependencies. That is, containers include applications that are decoupled from an underlying host infrastructure (e.g., operating system). By including the run time dependencies with the container, the container may perform in the same manner regardless of the host in which it is operating. The containers may be easy deploy in different hosts and may not to be rewritten for different implementations. Furthermore, utilizing containers to perform industrial automation processes may reduce the amount of data communicated within (or out of) the industrial automation system 10, thereby potentially decreasing network latency, freeing up bandwidth, or both.

In some embodiments, containers may be stored in a container registry 26 (e.g., a cloud-based container registry) as container images 28. The container registry 26 may be any suitable data storage or database that may be accessible to the container orchestration system 24. The container orchestration system 24 may use the container registry 26 as a container repository to store, distribute, and track the containers. The container image 28 may correspond to an executable software package that includes the tools and data employed to execute a respective application. That is, the container image 28 may include related code for operating the application, application libraries, system libraries, runtime tools, default values for various settings, and the like. For example, the related code may include digital twin code corresponding to an industrial automation device (e.g., motor, protection device, switchgear, or compressor) of the industrial automation system 10. The industrial automation device may receive (e.g., download) a container including the digital twin code. When executing the container, the industrial device may implement the digital twin to simulate processes performed by the industrial automation device. Additionally, the container image 28 may be updated based on certain operational changes (e.g., status, parameters, attributes) associated with the industrial automation device. The industrial automation device may receive an updated container (e.g., including updated code associated with new or improved functions) and update the digital twin by executing the updated container. As such, the digital twin may represent the industrial automation device more accurately throughout the lifecycle of industrial automation device to improve operations of the industrial automation device.

In some cases, certain industrial automation devices (e.g., non-compute-enabled devices) may not have memory or other computing resources to implement digital twins at a device level (referred to as device twins) and properly manage and replicate data in the device twins. In some embodiments, multiple device twins corresponding to the industrial automation devices of the industrial automation system 10 may be integrated or combined into a digital twin at a system level representing the industrial automation system 10. The digital twin may be implemented in an edge computing device that is communicatively coupled to the industrial automation devices. The edge computing device may execute a digital twin container that includes code associated with the digital twin. In some embodiments, the digital twin container may include multiple device twin containers that, when being executed, may simulate the operations of the multiple device twins corresponding to the industrial automation devices in the edge computing device. Such container approach may allow external, non-operation impacting updates to device twin containers without direct updates to the industrial automation devices. Moreover, utilizing containerized edge computing device positioned closer to the industrial automation devices may reduce the timing and amount of data communicated to a cloud computing system (e.g., system managing maintenance for the industrial automation system 10).

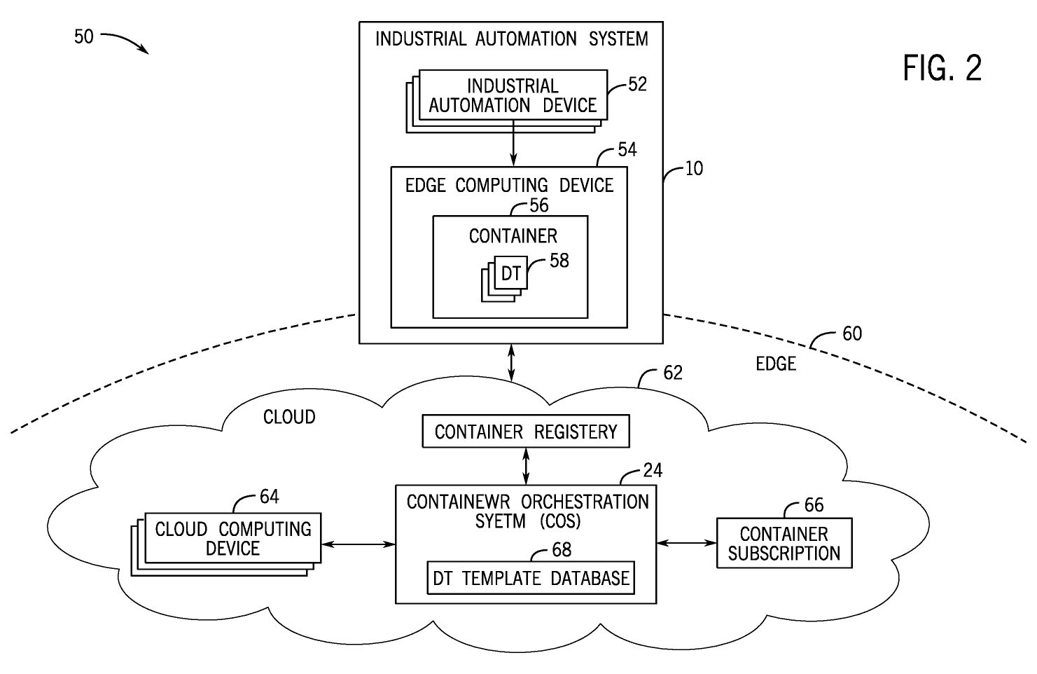

With the foregoing in mind, FIG. 2 is a block diagram of an industrial automation device management system 50 that may be used to remotely access the industrial automation system 10 of FIG. 1. The industrial automation device management system 50 includes industrial automation devices 52 of the industrial automation system 10, such as motor, sensors, protection device, switchgear, compressor, controllers, and so on. The industrial automation devices 52 may communicatively couple to an edge computing device 54 (e.g., a drive) located at an edge 60 of a cloud 62 (e.g., an industrial network). The edge computing device 54 may include a container 56 (e.g. a software container). One or more digital twins 58 may be implemented within the container 56. The digital twins 58 may be virtual instances (e.g., digital representations) of the industrial automation system 10. The digital twins 58 may provide flexible ways in which the edge computing device 54 may be implemented to monitor and control the industrial automation system 10. In some embodiment, each of the digital twins 58 may represent one aspect (e.g., thermal, kinetic, pressure, acoustic, or power aspect) of the industrial automation system 10,

The cloud 62 may be implemented by a variety of computing devices (e.g., cloud computing devices 64), storage devices, and connecting devices (e.g., routers, switches, gateways). The industrial automation device management system 50 may use the cloud 62 to facilitate communication between the industrial automation devices 52, the edge computing device 54, the container orchestration system 24, and other relevant systems or components. The cloud 62 may include one or more wired or wireless networks, including, but not limited to, local area networks (LANs), wide area networks (WANs), wireless WANs (WWANs), wireless LANs (WLANs), mobile communications networks (e.g., 3G, 4G, 5G, Edge, etc.), and so forth. For example, an asset management system may use a local area network (LAN) that includes a variety of computing and network devices including, but not limited to, switches, servers (e.g., processors), storage (e.g., memory), and routers. The above-mentioned systems/devices may communicate with each other using a variety of communication protocols, such as Open Database Connectivity (ODBC), TCP/IP Protocol, Distributed Relational Database Architecture (DRDA) protocol, Database Change Protocol (DCP), HTTP protocol, Bluetooth, Wi-Fi, Near Field Communication (NFC), other suitable current or future protocols, or combinations thereof.

As illustrated, the cloud 62 includes the container orchestration system 24, the container registry 26, the cloud computing devices 64, and a container subscription component 66. The container orchestration system 24 may include a digital twin template database 68 that stores various digital twin templates (e.g., Digital Twin Definition Language (DTDL) templates) associated with the industrial automation system 10 and the components (e.g., the industrial automation devices 52) of the industrial automation system 10. The DTDL may be used to create a container, when executed by a computing device (e.g., edge computing device 54), implement a digital representation (e.g., digital twin 58) of real-world things, places, and industrial or business processes, and the like. As such, the DTDL may include data structures, functions, expected inputs, expected outputs, and other elements for generating the digital representation. The digital representation may output insights that may lead to better products, optimize operations and costs, create breakthrough user experiences, and so on. In some embodiments, digital twin templates may correspond to certain aspects of the industrial automation system 10 at the system level, and other digital twin templates may correspond to the industrial automation devices 52 at the device level. The container orchestration system 24 may use the container subscription component 66 to provide a container subscription/publication service for the edge computing device 54. The container subscription/publication service may include periodical monitoring the container registry 26 to identify a new or updated container and sending a notification to prompt the edge computing device 54 to receive the new or updated container. Each of the container orchestration system 24, the container registry 26, the cloud computing devices 64, and the container subscription component 66 may include one of more processors of the computing devices that may execute computer-readable instructions stored on memory/storage devices of the computing devices.

In some embodiments, the container orchestration system 24 may collect information associated with the industrial automation system 10 during an initialization stage (e.g., a testing stage of the industrial automation system 10). For instance, the container orchestration system 24 may collect the operational technology (OT) data (e.g., regarding operation, status, configuration, specification, operational modes) from the industrial automation devices 52 via the edge computing device 54. The OT data may include OT datasets each generated from a specific device of the industrial automation devices 52. Each OT dataset may include a unique dataset identifier associated with a corresponding device of the industrial automation devices 52.

Based on received OT datasets (e.g., using dataset identifiers), the container orchestration system 24 may query the digital twin template database 68 to retrieve digital twin templates corresponding to the dataset identifiers. The digital twin templates may include information related to the types of devices and equipment that are specified by the OT datasets. That is, the OT datasets may indicate a number of industrial automation devices 52 that may be present, the types of the industrial automation devices 52, the operational parameter data (e.g., control settings) for each of the industrial automation devices 52, the function of each of and the entire fleet of the industrial automation devices 52, and the like. The container orchestration system 24 may then generate individual device twin containers based on the digital twin templates and other relevant information (e.g., configuration, specification, or mode) in the OT dataset. For example, the container orchestration system 24 may generate initial code for a device twin container associated with a specific device based on a digital twin template corresponding to a type of device that include the specific device. Next, the container orchestration system 24 may customize the initial code using the relevant information that may include specific (e.g., unique) details regarding the specific device. Each device twin container may include a unique container identifier correlated with the unique dataset identifier associated with the corresponding device. The container orchestration system 24 may utilize mappings (e.g., in a mapping file) to identify the correlations between dataset identifiers and container identifiers associated with different industrial automation devices 52.

In some embodiments, the container orchestration system 24 may integrate the individual device twin containers into a system-level digital twin container representing the industrial automation system 10 at the system level. The container orchestration system 24 may utilize one or more system files (e.g., configuration files) that include information related to a scope (e.g., aspect) represented by the system-level digital twin container, information detailing relations between the scope and other scopes (e.g., aspects) of the industrial automation system 10, information detailing relations between the system-level digital twin container and the device twin containers, and information detailing relations between the individual device twin containers, and the like. The container orchestration system 24 may store the device twin containers, the system-level digital twin container, and the configuration files into the container registry 26.

In some embodiments, the container orchestration system 24 may cause the container registry 26 to push a copy of the digital twin container (e.g., container 56) to the edge computing device 54. After receiving the container 56, the edge computing device may execute the container 56 to implement a digital twin representing the industrial automation system 10 (e.g., with respect to thermal aspect of the industrial automation system 10). The processes described above may continue as the operations of the industrial automation system 10 continue, thereby implementing more digital twins (e.g., representing other aspects, such as) that become part of the digital twins 58.

Although FIG. 2 is depicted with respect to the industrial automation device management system 50, it should be understood that the components described with respect to FIG. 2 are exemplary figures and the industrial automation device management system 50 may include additional or fewer components as detailed above. For instance, each of the container orchestration system 24, the container registry 26, the edge computing device 54, the cloud computing devices 64, and the container subscription component 66 may include one or more databases.

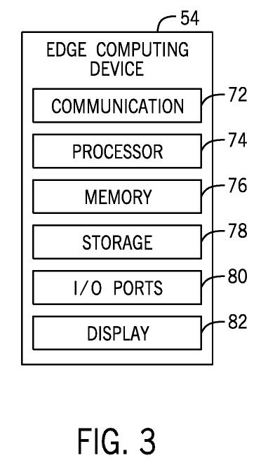

FIG. 3 a block diagram of an example edge computing device (e.g., edge computing device 54) with containers that may be used in the industrial automation device management system 50 of FIG. 2. The edge computing device 54 may include a communication component 72, a processor 74, a memory 76, a storage 78, input/output (I/O) ports 80, a display 80, and the like. The communication component 72 may be a wireless or wired communication component that facilitates communication between the container orchestration system 24 and the edge computing device 54, or any other suitable systems, components, or devices. The processor 84 may be any type of computer processor or microprocessor capable of executing computer- executable code. The processor 84 may also include multiple processors each including processing circuitry that may perform the operations described below.

The memory 86 and the storage 88 may be any suitable article of manufacture that may serve as media to store processor-executable code, containers (e.g., container 56) data (e.g. OT data), or the like. These articles of manufacture may represent computer-readable media (i.e., any suitable form of memory or storage) that may store the processor-executable code used by the processor 84 to perform the presently disclosed techniques. The memory 86 and the storage 88 may represent non-transitory computer-readable media (e.g., any suitable form of memory or storage) that may store the processor-executable code used by the processor 84 to perform various techniques described herein. It should be noted that non-transitory merely indicates that the media is tangible and not a signal.

The I/O ports 80 may couple to one or more sensors 18, one or more input devices, one or more displays, or the like to facilitate human or machine interaction with the industrial automation system 10. For example, based on a notification provided to a user via the display 82, the user may use an input device to instruct certain adjustments of one or more of the industrial automation devices 52 of the industrial automation system 10.

The display 82 may operate to depict visualizations associated with software (e.g., containers) or executable code being processed by the processor 84. In one embodiment, the display 82 may be a touch display capable of receiving inputs from a user (e.g., operator) of the industrial automation system 10. The display 82 may be any suitable type of display, such as a liquid crystal display (LCD), plasma display, or an organic light emitting diode (OLED) display, for example. Additionally, in one embodiment, the display 82 may be provided in conjunction with a touch-sensitive mechanism (e.g., a touch screen) that may function as part of a control interface for the industrial automation system 10.

Although FIG. 3 is depicted with respect to the edge computing device 54, it should be noted that other computing systems (e.g., the container orchestration system 24) or devices may also include the same or similar components to perform, or facilitate performing, the various techniques described herein. Moreover, it should be understood that the components described with respect to FIG. 3 are exemplary figures and the edge computing device 54 and other suitable computing systems or devices may include additional or fewer components as detailed above.

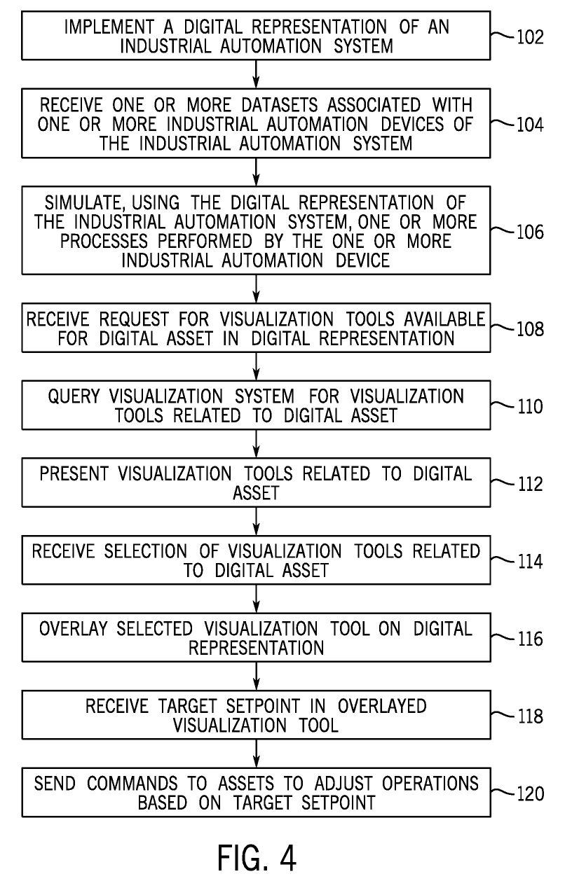

With the foregoing in mind, FIG. 4 is a flow diagram of a process 100 for overlaying visualization tools on a digital representation of the industrial automation system 10 of FIG. 1 using the edge computing device 54 of FIG. 3. By way of example, the process 100 may be performed by the edge computing device 54 using processing circuitry (e.g. the processor 74 included in the edge computing device 54) executing computer-readable instructions stored on memory or storage (e.g., the memory 76 or storage 78) of the edge computing device 54.

Although the process 100 described in FIG. 4 is described in a particular order, it should be noted that the process 100 may be performed in any suitable order and is not limited to the order presented herein. It should also be noted that although each processing block is described below in the process 100 as being performed by the edge computing device 54, other suitable devices may perform the methods described herein.

Referring now to FIG. 4, at block 102, the edge computing device 54 may implement a digital representation (e.g., digital twin 58) of the industrial automation system 10. For example, the edge computing device 54 may receive (e.g., download) a container (e.g., container 56) from a cloud-based container registry (e.g., container registry 26). In some embodiments, the computing device 54 may receive the container using a cloud-based container subscription service (e.g. provided by the container subscription component 66). For instance, the container subscription component 66 may continuously or periodically (e.g., every day, every 3 days, every week, or every month) monitor the container registry 26 to identify whether a new container or an updated version of an existing container is available. The container subscription component 66 may send a notification indicative of the new or updated container to the edge computing device 54 to prompt the edge computing device 54 to receive the new or updated container.

The received container may include a set of device twin code corresponding to individual industrial automation devices (e.g., industrial automation devices 52) at a device level to represent the operations of the respective industrial automation devices. When executing the set of device twin code, the edge computing device 54 may implement a set of device twins, each device twin representing a corresponding industrial automation device of the industrial automation system 10. The edge computing device 54 may utilize each individual device twin to simulate various operations (e.g., parameter setting, operation mode, fault identification, maintenance, troubleshooting) of each corresponding industrial automation device at the device level.

The received container may also include a digital twin code corresponding to the industrial automation system 10 at a system level. When executing the digital twin code, the edge computing device 54 may integrate the set of device twins into the digital twin 58 representing the industrial automation system 10. The digital twin 58 may include hierarchical levels of the industrial automation system 10, such as information related to an aspect (e.g., thermal aspect) represented by the digital twin 58, relations between the aspect and other aspects (e.g., kinetic, pressure, acoustic, and power aspects) of the industrial automation system 10, relations between the digital twin 58 and the device twins, and relationships between the device twins, and the like.

The digital twin 58 may also include data structures (e.g., predetermined data structures) regulating procedures and formats used to process OT data (e.g., data received from the industrial automation devices 52). For example, the digital twin 58 may have functions to manage data reception and transmission (e.g., filtering the OT data and only transmitting certain portions of the OT data to the container orchestration system 24), format or convert the received OT data into a standard data format based on the predetermined data structures that may be shared by each device twin, setup input/output ports for each device twin based on the hierarchical levels of the industrial automation system 10 to facilitate data communication between the device twins within the digital twin 58, and so on.

Furthermore, the digital twin 58 may include a variety of computational algorithms to facilitate data analysis and processing using the OT data received from the industrial automation device 52. For example, the computational algorithms may include machine learning algorithms and/or artificial intelligence algorithms. The digital twin 58 may utilize the OT data and apply the machine learning algorithms to identify correlations, trends, patterns, potential issues, and other properties associated with individual industrial automation devices 52 and/or the industrial automation system 10. In some embodiments, the digital twin 58 may include one or more models (e.g., mathematic models) that may be used to simulate various operations (e.g., parameter setting, operation mode, fault identification, maintenance, troubleshooting, and so on) of the industrial automation system 10. For example, the digital twin 58 may perform a machine learning process and generate a mathematical model based on a sample of the clean data, known as “training data,” in order to make predictions or decisions without being explicitly programmed to perform the task.

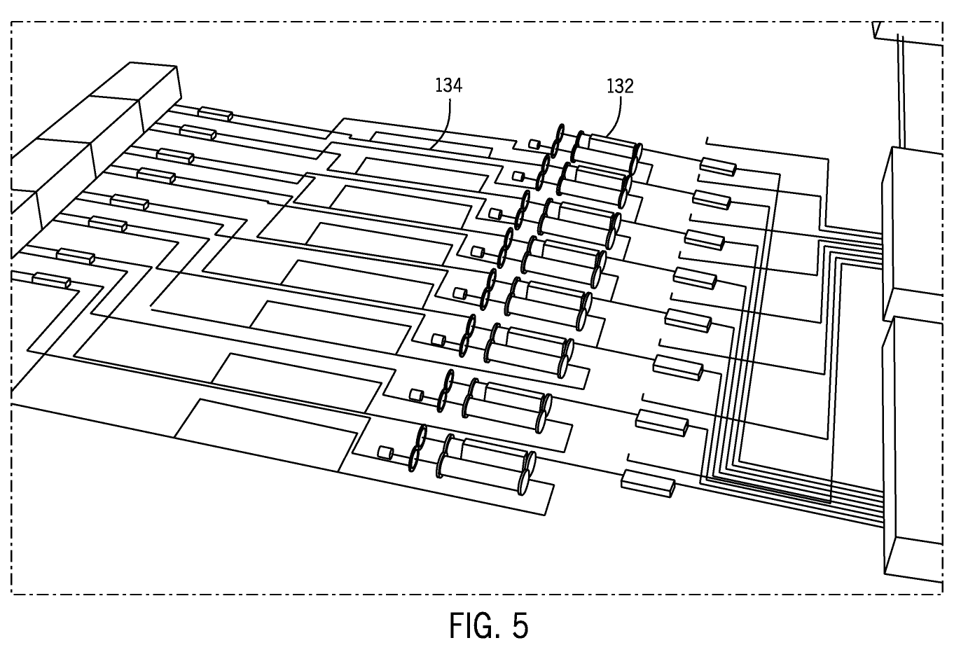

In addition, the received container may also perform various visualization functions via a visualization platform in conjunction or coordination with the digital twin 58. As such, containers executing the visualization functions may exchange data with the containers executing the digital twin 58 to generate visualizations (e.g., graphs, charts, heat maps) that may be presented within a visualization representing the digital twin 58. With this in mind, the visualization platform may receive datasets from the digital twin 58 (e.g., via containers) and generate a simulation visualization representative of operations performed by the industrial automation system 10 associated with the digital twin 58. For instance, FIG. 5 illustrates an example chiller system that may circulate refrigerant or other fluids across devices to control temperature in large spaces. As such, the digital twin 58 may include information related to the types of devices that may be present in the chiller system, the operational parameters of those devices, the inputs provided to those devices, the expected outputs of those devices, and the like. The visualization platform may include data that corresponds to a visualization that depicts or represents the respective devices. In addition, based on the data simulated by the digital twin 58, the visualization platform may present visualization (e.g., animations) that mimic the operations performed by the respective devices or individuals that may be part of the operations.

In some embodiments, the visualization platform may present the visualizations of the respective system without any datasets representing real-time operational values or the like. However, to better asses the operations of the devices, analytical visualizations representative of the operations of these devices may be generated by the visualization platform. In some embodiments, the analytical visualizations may be generated using a different container or within the container executing the visualization platform.

After the digital twin 58 is implemented (e.g., downloaded and executed) in the container (e.g., container 56), at block 104, the edge computing device 54 may receive one or more datasets associated with one or more industrial automation devices (e.g., industrial automation device 52) of the industrial automation system (e.g., industrial automation system 10). For example, each of the one or more datasets may be generated from a specific industrial automation device 52 and may include a unique dataset identifier associated with that specific industrial automation device 52. The one or more datasets may include the OT data, such as operational parameters, operational status, controller reading, sensor data, operational modes, alarm conditions, and so on. In some embodiments, the edge computing device 54 may format or convert the one or more datasets into the standard data format that may be shared by each device twin and setup input/output ports for each device twin to facilitate a distribution of the one or more datasets between the device twins.

At block 106, the industrial automation device 52 may simulate, using the digital representation (e.g., digital twin 58) of the industrial automation system 10, one or more processes performed by the one or more industrial automation devices 52. For example, the edge computing device 54 may use the digital twin 58 to run simulations related to the one or more processes, such as operation performance analysis, diagnostics for existing issues, prediction for potential problems, and the like. The digital twin 58 may run the simulations based on the one or more datasets received from the one or more industrial automation devices 52 and other relevant data (e.g., historical data) associated with the one or more industrial automation devices 52. In some embodiments, the digital twin 58 may identify relevant devices of the industrial automation devices 52 (e.g., based on the one or more datasets that may include certain identifiers associated with relevant devices), and cause relevant device twins corresponding to the relevant devices to run simulations at the device level. Furthermore, the digital twin 58 may receive device twin simulation result and run simulations at the system level based on the device twin simulation result. The edge computing device 54 may also use the digital twin 58 to analyze the simulation result (e.g., using the machine learning algorithms and/or artificial intelligence algorithms). For instance, the one or more processes may include process for optimize conveyor speeds of machine conveyors of a mechanized assembly line. The digital twin 58 may receive speed simulations (e.g., increasing speeds by 10% from current speeds) result from device twins corresponding to the machine conveyors and use the result as input to run a simulation to determine whether the increased speeds of the machine conveyors may overload the mechanized assembly line.

Executing digital twins (e.g., digital twin 58) on edge devices (e.g., edge computing device 54) may provide various advantages for operating industrial systems (e.g., industrial automation system 10) using vast amount of OT data, advanced edge computing resources (e.g., fast data processing, prompt device control), and abundant cloud computing and storage resources. In some cases where one or more industrial systems may be integrated to form a sophisticated system (e.g., an automated manufacturing system), the system may include a great number of industrial automation devices and sensors that may produce vast amount of OT data. With certain limitations (e.g., limited connectivity), sending such large amount of data to digital twins executed on cloud computing systems/device may cause data communication latency and delayed response time. In contrast, using digital twins on the edge devices may enable data processing locally (e.g., close to the data sources) for more efficient processing and analysis to trigger real-time responses, thereby increasing network bandwidth to cloud computing devices and other network devices.

The edge-based digital twins may also deliver fast analytics (e.g., identifying potential issues based on simulations), quick solution (e.g., to identified issues), and prompt commands to related devices (e.g., to adjust operations to solve the identified issues). Moreover, the edge-based digital twins may regulate data communications such that a limited amount of OT data is transmitted to the cloud computing systems/devices. In this way, the cloud computing systems/devices may focus on larger scaled data collection (e.g., collecting data from other relevant industrial systems), data mining, advanced simulations based on transmitted OT data from the automated manufacturing system and other relevant data (e.g., historical data and/or synthetic data from other industrial systems related (e.g., similar, upstream, downstream) to the automated manufacturing system), and the like. Furthermore, using containerized digital twins implemented on edge devices may allow fast and convenient deployment (e.g., with reduced coding, less dependency on running environment) of digital twins in new places where there is limited computing resources (e.g., limited memory and/or data processing capabilities associated with certain industrial devices) and/or network connectivity, or where there are industrial devices having different running environment (e.g., operating systems or libraries from different vendors).

Additionally, using containerized digital twin implemented on edge devices may improve network security. For instance, certain sensitive OT data associated with the industrial automation system 10 may be stored locally on the edge computing device 54. In some cases, the OT data may be encrypted (e.g., adding meta-data) by the edge computing device 54 using the digital twin 58 such that only the encrypted OT data is transmitted to the cloud computing systems/devices.

At block 108, the edge computing device 54 may receive a request to display visualization tools that may be available to analyze datasets output by the digital twin 58. That is, the digital twin 58 or simulations may be generated using various visualization tools that depict a current value of a digital output. In the present embodiments, the visualization tools may be capable of providing analysis visualizations in a flexible manner on the digital twin visualizations. That is, as the digital twin 58 or simulation is being executed, virtual monitors, meters, or graphs may be placed within the digital twin visualization, such that the analysis visualizations may be overlaid onto the digital twin visualization (e.g., in coordination with visualization platform) to provide real time insight into the performance of the respective equipment.

With this in mind, after receiving the request from the user, the edge computing device 54 may query available visualization tools, platforms, containers, and the like based on the parameters of the request. The request, for example, may reference a particular industrial automation device, an OT device, and the like. In addition, the request may include parameters related to a type of analysis, a type of graph, a type of visualization, and the like. The visualization parameters may include a graph of a simulated variable over time, such that the graph is depicted in real time and dynamically changes based on the outputs of the digital twin 58.

At block 110, the edge computing device 54 may query the various visualization systems that may be accessible to it to identify one or more visualization tools that may be relevant and available to the user. As mentioned above, the various visualization systems a visualization platform, a containerized application, or the like. In some embodiments, the edge computing device 54 may cross reference the digital asset and the available datasets with visualization tools that may be used to analyze the respective datasets.

After identifying visualization tools that may be relevant with respect to the digital assets and the available data sets, at block 112, the edge computing device 54 may present the identified visualization tools for the user to select. The visualization tools may include any suitable visualizations that may be presented with respect to the digital assets. As such, the visualization tools may include heat maps that modify the digital assets presentation to indicate some data (e.g., intensity, speed, temperature). For instance, the heat maps may modify a color of a digital asset based on the respective data relative to a respective threshold.

The visualization tools may also include time-series graphs that illustrate performance data, such as temperature, production rate, energy consumption, utilization, and the like over a period of time. In this case, the time-series graph visualization may include a rolling time window that presents the real time values with respect to the values over some period of time. In this way, the user may detect trends, changes, and other insights based on the changes in the datasets over time. In some embodiments, the edge computing device 54 may automatically adjust the time period of the time-series graph based on a detected trend, such that the user may view the trend. Additionally, the user may provide input to the edge computing device 54 to specify the time period.

The visualization tools may also include resource utilization charts that may depict a utilization value for the respective digital asset. The resource utilization charts may include bar or pie charts that present the utilization data to better equip a user to determine workload balances across the industrial automation system 10.

At block 114, the edge computing device 54 may receive a selection of a visualization tool from the list of identified visualization tools. In some embodiments, the edge computing device 54 may automatically select a visualization tool based on a frequency in which other users select the same visualization tool for a particular digital asset, visualizations tools that are associated with the respective digital assets, trends detected in the datasets, and the like.

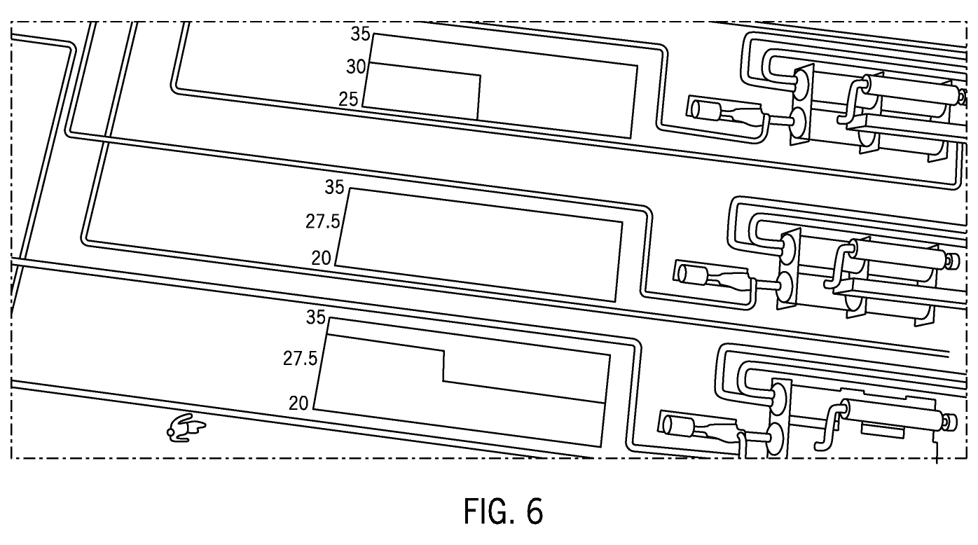

At block 116, the edge computing device 54 may overlay the selected visualization tool on the visualization depicting the digital twin 56. In some embodiments, the visualization tool may be overlaid in an empty space adjacent to the respective digital asset. For example, referring to FIG. 5, the selected visualization tool may be related to devices 132 of the digital twin visualization. As such, the edge computing device 54 may identify available space 134 that may exist adjacent to the devices 132. After identifying the suitable available space 134, the edge computing device 54 may overlay the visualization tool in the available space 134. By way of example, as shown in FIG. 6, the overlaid visualization may include a time graph that depicts a variable over time. The time window may include a fixed window of time and the datasets presented within the overlaid visualization may change based on the respective output.

In some embodiments, the edge computing device 54 may receive a target setpoint via the overlaid visualization. That is, the user may engage with the overlaid visualization by providing an input, selecting a portion of the graph, and the like. For example, the user may provide an input into the graph visualization to indicate a set point.

At block 118, the edge computing device 54 may receive the target setpoint and determine adjustments to various other assets to cause the respective asset to achieve the target setpoint. At block 120, the edge computing device 54 may send commands to the various assets to achieve the respective target setpoint. That is, the edge computing device 54 may determine operational adjustment for digital assets to achieve the target setpoint. The digital assets may adjust their operations in accordance with the commands, and the resulting effects may be simulated by the digital twin 58. The user may view the effects in the resulting visualization tool in which the set point was input.

Although the embodiments described herein are described as being performed with the digital twin 58, it should be noted that the digital twin 58 may represent physical devices and systems that perform physical operations. As such, the commands may be sent to control systems and other devices to be implemented in the physical system. In some embodiments, the edge computing device 54 may send the commands after verifying that the target setpoint is achievable via the digital twin 58. Indeed, if the target setpoint is achievable, other parameters may fall out of a desired range or threshold. In this case, the edge computing device 54 may send a request to a user device for approval to implement the commands to the physical device. The request may include information related to the other parameters. In some embodiments, the visualization tools depicted on the visualization parameter may generate additional visualizations that indicate the other parameters falling out of range or within a threshold.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…,” it is intended that such elements are to be interpreted under 35 U.S.C. 112(f). However, for any claims containing elements designated in any other manner, it is intended that such elements are not to be interpreted under 35 U.S.C. 112(f).

What is claimed:

1. A method, comprising:
receiving, via a processing system, one or more datasets associated with one or more industrial devices within an industrial system;
simulating, via the processing system, one or more processes performed by the one or more industrial devices based on the one or more datasets;
presenting, via the processing system, a digital representation of the industrial system based on the one or more processes;
receiving, via the processing system, a request for one or more visualization tools associated with one or more digital assets corresponding to the one or more industrial devices within the digital representation;
identifying, via the processing system, one or more positions for the one or more visualization tools based on one or more available spaces within the digital representation; and
overlaying, via the processing system, the one or more visualization tools at the one or more positions.

2. The method of claim 1, wherein the one or more visualization tools comprise one or more time-series charts.

3. The method of claim 2, wherein the one or more time-series charts are generated based on real-time data associated with the one or more digital assets.

4. The method of claim 3, wherein each of the one or more time-series charts comprise a period of time determined based on a detected trend within the one or more datasets.

5. The method of claim 1, comprising:
receiving one or more inputs via the one or more visualization tools, wherein the one or more inputs correspond to one or more target set points for the one or more digital assets; and
sending one or more commands to one or more industrial devices based on the one or more inputs.

6. The method of claim 5, wherein the one or more commands are sent after verifying that one or more parameters associated with the digital representation is less than a threshold.

7. The method of claim 1, wherein the one or more visualization tools are generated by a container.

8. A non-transitory computer-readable medium comprising computer-executable instructions that, when executed, are configured to cause a processing system to perform operations comprising:
receiving one or more datasets associated with one or more industrial devices within an industrial system;
simulating one or more processes performed by the one or more industrial devices based on the one or more datasets;
presenting a digital representation of the industrial system based on the one or more processes;
receiving a request for one or more visualization tools associated with one or more digital assets corresponding to the one or more industrial devices within the digital representation;
identifying one or more positions for the one or more visualization tools based on one or more available spaces within the digital representation; and
overlaying the one or more visualization tools at the one or more positions.

9. The non-transitory computer-readable medium of claim 8, wherein the one or more visualization tools comprise one or more time-series charts.

10. The non-transitory computer-readable medium of claim 9, wherein the one or more time-series charts are generated based on real-time data associated with the one or more digital assets.

11. The non-transitory computer-readable medium of claim 10, wherein each of the one or more time-series charts comprise a period of time determined based on a detected trend within the one or more datasets.

12. The non-transitory computer-readable medium of claim 8, wherein the computer-executable instructions are configured to cause the processing system to perform the operations further comprising:
receiving one or more inputs via the one or more visualization tools, wherein the one or more inputs correspond to one or more target set points for the one or more digital assets; and
sending one or more commands to one or more industrial devices based on the one or more inputs.

13. The non-transitory computer-readable medium of claim 12, wherein the one or more commands are sent after verifying that one or more parameters associated with the digital representation is less than a threshold.

14. The non-transitory computer-readable medium of claim 8, wherein the one or more visualization tools are generated by a container.

15. A system, comprising:
a memory configured to store one or more instructions; and
a processing system configured to execute the one or more instructions to cause the processing system to perform operations comprising:
receiving one or more datasets associated with one or more industrial devices within an industrial system;
simulating one or more processes performed by the one or more industrial devices based on the one or more datasets;
presenting a digital representation of the industrial system based on the one or more processes;
receiving a request for one or more visualization tools associated with one or more digital assets corresponding to the one or more industrial devices within the digital representation;
identifying one or more positions for the one or more visualization tools based on one or more available spaces within the digital representation; and
overlaying the one or more visualization tools at the one or more positions.

16. The system of claim 15, wherein the one or more visualization tools comprise one or more time-series charts.

17. The system of claim 16, wherein the one or more time-series charts are generated based on real-time data associated with the one or more digital assets.

18. The system of claim 17, wherein each of the one or more time-series charts comprise a period of time determined based on a detected trend within the one or more datasets.

19. The system of claim 15, wherein the computer-executable instructions are configured to cause the processing system to perform the operations further comprising:
receiving one or more inputs via the one or more visualization tools, wherein the one or more inputs correspond to one or more target set points for the one or more digital assets; and
sending one or more commands to one or more industrial devices based on the one or more inputs.

20. The system of claim 15, wherein the one or more commands are sent after verifying that one or more parameters associated with the digital representation is less than a threshold.
